(19) United States
(12) Patent Application Publication
(10) Pub. No.: US 2026/0298886 A1
(43) Pub. Date: Oct. 1, 2026

(54) Capillary Assembly for use in Liquid Chromatography

(71) Applicant: Dionex Softron GmbH, Germering (DE)

(72) Inventors: Daniel Bürger, Raisting (DE); Michael Schadl, Schiltberg (DE)

(21) Appl. No.: 19/097,246

(22) Filed: Apr. 1, 2025

(51) Int. Cl. G01N 30/60

(52) U.S. Cl. CPC G01N 30/6078; G01N 30/6026

(57) ABSTRACT

The present invention relates to a capillary assembly comprising: a capillary tube; a thrust piece surrounding at least a distal section of the capillary tube, the thrust piece defining an axial direction; a sealing element; wherein at least a portion of the sealing element is arranged distally from the capillary tube; wherein the sealing element is configured to move in the axial direction relative to the thrust piece. The present invention also relates to a system comprising the assembly and a bushing unit for receiving the assembly, or at least a distal section thereof, to a use of the assembly or the system in high performance liquid chromatography, and to a method for providing the assembly.

The present invention relates generally to the field of liquid chromatography. More particularly, it relates to a capillary assembly for connecting different fluid capillaries to each other.

High-Performance Liquid Chromatography (HPLC) is a method for separating samples into their constituent components. The components may be separated for later use, for example, and their proportions in samples may be quantified. HPLC is typically carried out at high pressures such as 500 bar or even higher, such as 1500 bar. That is, fluid at these high pressures, containing the sample for analysis, is pushed through a separation or chromatography column containing adsorbent material. Different components of the sample interact different depending on their affinity to the adsorbent material and are eluted from the separation column at different rates, allowing their separation.

Fluid is typically transported by means of fluid capillaries, that may also be referred to as capillary tubes, or simply, capillaries. Capillary tubes made of stainless steel, glass (fused silica) or polyether ether ketone (PEEK™) may typically be used to fluidically connect HPLC devices, such as a sample reservoir and the separation column. Titanium, fused silica, MP35N™ or PEEK™ capillary tubes may also be used for biocompatible HPLC systems in order to be as iron-free as possible. As described above, capillary tubes may carry fluid at high pressure and may have to be connected to other capillary tubes to allow establishing longer fluid paths. Suitable connections or connecting elements may then be required to connect such capillary tubes to each other. In particular, such connecting elements should allow connection of two capillary tubes, for example, without, at least a significant, pressure drop across the connection. Such connecting elements may comprise, inter alia, sealing elements that may allow a fluid-leak-resistant connection between capillary tubes.

Increasing requirements for higher throughput and finer separation may necessitate use of even higher pressures in HPLC, such as in Ultra High-Performance Liquid Chromatography (UHPLC). Thus, improvements to capillary tube connection and sealing elements may be of advantage. It is an aim of the present technology to provide an improved connection element, viz., an improved plug unit, that may allow for higher pressures and greater wear-resistance of capillary tube connections.

WO 2010/063267 A1 discloses a plug unit and system for connecting capillary tubes, especially for high-performance liquid chromatography, with a plug capillary tube projecting through a hole of a plug housing, which is detachably connectable to a bushing unit. The plug capillary tube front end projects into a capillary tube receptacle in the bushing unit with its end face essentially aligned opposite a front end of a bushing capillary tube or a bushing capillary passage opening of the bushing unit, the end face of which is butted against. The plug housing applies a force, with its end face facing the plug capillary tube end, directly or indirectly on an annular sealing element surrounding the plug capillary tube in the region of the front end of the plug capillary tube such that the front end of the plug capillary tube is sealed through deformation of the sealing element against the capillary tube receptacle opening.

WO 2010/133192 A1 describes a plug unit for connecting capillary tubes that includes a plug housing that has an axial borehole, a plug capillary tube that projects through the axial borehole, and a sealing element that surrounds the plug capillary tube. The front end of the plug capillary tube is sealed by an elastic and/or plastic deformation of the sealing element against the capillary tube receptacle opening of a bushing unit. A hollow cylindrical pressure piece is provided that surrounds the sealing element in an axial region facing away from the end surface of the plug capillary tube, and the pressure piece has a rearward end side that faces away from the end surface of the plug capillary tube and that can be loaded by the plug housing with an axial pressure force when the plug unit and bushing unit are connected.

DE 10 2011 050 037 B3 describes a plug unit for connecting capillaries, in particular for high-performance liquid chromatography, wherein a sealing element sealing the capillary protrudes at least partially into the interior of the capillary, while a section of the sealing element protruding axially from the capillary for an axial or radial plastic and/or elastic deformation can be acted upon by a pressure force introduced via the capillary.

DE 10 2017 129 674 A1 describes a plug unit configured for use in high performance liquid chromatography. The plug unit comprises a capillary comprising a distal capillary surface; a sealing element, wherein at least a portion of the sealing element is disposed distally of the distal capillary surface, and a biasing element configured to bias the capillary to the sealing element.

In general, a plug unit may be screwed into a corresponding bushing unit, where the plug and the bushing units may both be configured to accept capillary tubes such that a fluid connection is established between the two capillary tubes via the plug and bushing units. A problem that may arise in using plug units may be that the inner bore of the sealing element may flow in after screwing in. In other words, due to repeated exposure to high pressure, a plastic, at least in part, deformation of the sealing element may occur such that the inner bore of the sealing element may get smaller over time. As a result, after screwing-in the plug unit several times, or possibly even once, the inner diameter of the sealing may have shrunk so much that there may be virtually no hole left. The capillary tube may then have increased back pressure or the plug unit may be clogged and may have to be replaced.

A further problem that may arise is that the sealing element may deform by flowing over an opening of the plug unit such that an effective area over which (axial) force is applied while screwing the plug unit into the bushing unit may increase. As a result, an increased force may have to be applied to the plug unit to achieve the same pressure.

One solution may be to use a harder material (e.g., PEEK with fillers such as glass fibers), that may not (plastically) deform as easily, for the sealing element. However, using the harder material may have the disadvantage that the sealing element may become more brittle and may break apart after some time. Moreover, achieving a fluid-leak-resistant seal with such a sealing element may also not be as easy as with one made of unfilled material.

The present invention seeks to overcome or at least alleviate the shortcomings and disadvantages of the prior art. More particularly, it is an object of the present invention to provide an improved plug unit for HPLC.

In particular, it is an aim of the present invention to provide a capillary assembly that may provide a high-pressure-resistant and more wear-resistant capillary connection. It is also an aim of the present invention to allow using a suitable material for the sealing element and to provide a process for improving the material properties. It is, yet further, an aim of the present technology to provide a capillary assembly in which the sealing element may be substantially more wear-resistant and that may also achieve a desired number of screw-in operations without replacing the sealing element. Even further, it is an aim of the present invention to achieve a flat plane between an opening of the capillary assembly and the sealing element thus preventing the sealing material swelling in front of the opening of the capillary assembly and the sealing element no longer making bottom contact with the bushing unit. These aims are met by the following aspects of the present invention.

According to a first aspect, the present invention relates to a capillary assembly comprising: a capillary tube; a thrust piece surrounding at least a distal section of the capillary tube, the thrust piece defining an axial direction; a sealing element; wherein at least a portion of the sealing element is arranged distally from the capillary tube; wherein the sealing element is configured to move in the axial direction relative to the thrust piece. Movement of the sealing element may be of advantage in enhancing wear-resistance of the sealing element as part of the contact force between the bushing unit and the capillary assembly may be provided by the thrust piece. Moreover, by being forced into a volume within the thrust piece, any possible deformation of the sealing element may occur closer to a proximal end of the sealing element than at a distal face in contact with the bushing unit. Thus, distribution of the contact force over a larger surface of the distal face of the sealing element, as described above, may be avoided.

A proximal part of the sealing element may be movable in the axial direction relative to the thrust piece. In other words, space may be provided in the thrust piece for movement of the proximal part of the sealing element in the axial direction. This space may also allow accommodation of any deformation of the sealing element, thus reducing increase in surface area of the distal face over prolonged use.

The thrust piece may comprise a recess and the sealing element may be coupled to the recess. The recess may allow for movement of the sealing element while also restricting a range of motion of the sealing element.

The sealing element may comprise an engagement element and the engagement element may be coupled to the recess. In particular, the recess may be configured to receive the engagement element.

An extension of the recess in the axial direction may be greater than an extension of the engagement element in the axial direction. Thus, the engagement element and, consequently, the sealing element, may move within the recess.

The thrust piece may comprise at least one hollow section defined by an inner and an outer wall. A hollow section, as used herein, may generally be understood to be a space defined by an inner wall and an outer wall.

The thrust piece may consist of the at least one hollow section. That is, the thrust piece may have only one hollow section. However, preferably, the thrust piece may have a plurality of hollow sections.

The recess may be arranged on the inner wall of the at least one hollow section.

The recess may be located closer to a distal end of the thrust piece than to a proximal end of the thrust piece.

The thrust piece may comprise a proximal end comprising a capillary entrance, and the thrust piece may be configured to receive the capillary tube through the capillary entrance.

The sealing element may be located so as to abut a distal end of the capillary tube.

The thrust piece may be configured to receive the sealing element, or at least a part thereof.

The thrust piece may be configured to receive the sealing element, or the part thereof, at a distal end of the thrust piece.

The sealing element may comprise a distal end.

The thrust piece may comprise a distal end.

The recess may comprise two shoulders, a proximal shoulder closer to a proximal end of the thrust piece and a distal shoulder closer to a distal end of the thrust piece. Closer may be understood to be with respect to the other shoulder as applicable.

A result of the extension of the recess, in the axial direction, being greater than an extension of the engagement element, in the axial direction, is the sealing element being configured to move between a distal position, wherein the distal shoulder abuts the engagement element, and a proximal position, wherein the proximal shoulder abuts the engagement element.

In the distal position, the distal end of the sealing element, or at least a part thereof, may extend beyond the distal end of the thrust piece, or at least a part thereof.

In the proximal position, the distal end of the sealing element, or at least a part thereof, may be level with the distal end of the thrust piece, or at least a part thereof. In other words, in the proximal position, the sealing element may be completely contained within the thrust piece. Further exemplarily, the distal end of the sealing element being level with the distal end of the thrust piece may be understood to comprise a configuration of the sealing element and the thrust piece such that a point proximal of the distal end of the sealing element is, at least substantially, also proximal of the distal end of the thrust piece and a point distal of the distal end of the sealing element is, at least substantially, also distal of the distal end of the thrust piece.

The distal end of the sealing element may comprise a distal face. In other words, the distal end of the sealing element may be contained in a plane.

The distal end of the thrust piece may comprise a distal face. In other words, the distal end of the thrust piece may be contained in a plane.

In the proximal position, the distal face of the sealing element may be level with the distal face of the thrust piece. In other words, the distal face of the sealing element and the distal face of the thrust piece may be contained in the same plane.

The recess may comprise a step, wherein the step may divide the recess into a side proximal of the step, and a side distal of the step. A side proximal of the step may be understood to comprise a portion of the recess that is closer to the proximal end of the plug unit and that does not contain the step. A side distal of the step may, similarly, be understood to comprise a portion of the recess that is closer to the distal end of the plug unit and that does not contain the step. In other words, the recess may comprise the proximal shoulder, the side proximal of the step, the step, the side distal of the step, and the distal shoulder, when viewed from the proximal end of the plug unit along the axial direction. The provision of the step may allow distribution of a normal reaction force applied by the recess on the sealing element in operation that may further aid in reducing wear of the sealing element as the force is not applied at one point/one end.

A diameter of the recess on the side proximal of the step may be different from a diameter on the side distal of the step and, preferably, the diameter of the recess on the side proximal of the step may be at most equal to the diameter on the side distal of the step.

The diameter of the recess on the side proximal and/or distal of the step may, at least substantially, be constant. A constant diameter may be of advantage in simplifying a manufacturing process of the thrust piece.

The sealing element may comprise a proximal end.

The engagement element may be located closer to the proximal end of the sealing element than to the distal end. Some of the compressive stress experienced by the sealing element in operation may be sustained by a part of the engagement element distal of engagement element. The more proximal arrangement of the engagement element may, thus, allow a larger portion of the sealing element to sustain this stress further contributing to reduced wear of the sealing element.

The proximal end of the sealing element may be configured to receive the capillary tube.

The sealing element may comprise a hollow section, preferably a plurality of hollow sections.

The plurality of hollow sections may comprise a proximal hollow section corresponding to a hollow section furthest in the proximal direction, a distal hollow section corresponding to a hollow section furthest in the distal direction, and an intermediate hollow section corresponding to a hollow section in between the distal and proximal hollow sections.

An inner diameter of the proximal hollow section of the sealing element may be different from, preferably greater than, an inner diameter of the distal hollow section.

The proximal hollow section may be configured to receive the capillary tube, particularly the distal end thereof.

The sealing element may co-extend, along the axial direction, with the capillary tube.

An outer wall of the proximal hollow section may comprise the engagement element.

The engagement element may comprise at least one rib.

The at least one rib may be an annular rib. That is, the rib may extend all the way round an outer surface of the sealing element.

The engagement element may comprise a plurality of ribs.

The plurality of ribs may be arranged circumferentially on an outer wall of the proximal hollow section.

At least one of the at least one rib may be tapered along the axial direction, wherein an extension of the at least one of the at least one rib, in a direction, at least substantially, perpendicular to the axial direction, may decrease in the proximal direction.

The distal shoulder of the recess may abut a distal end of at least one of the at least one rib.

The proximal shoulder of the recess may abut a proximal end of at least one of the at least one rib. In particular, the proximal shoulder may prevent the sealing element from being pushed out of the thrust piece when the capillary tube is inserted into the thrust piece and may, thus, allow for relative motion between the capillary tube and the sealing element.

The proximal end of the sealing element may comprise a proximal end of at least one of the at least one ribs.

The thrust piece may comprise a plurality of hollow sections.

The thrust piece may comprise a proximal hollow section corresponding to a hollow section furthest in the proximal direction and a distal hollow section corresponding to a hollow section furthest in the distal direction.

An inner diameter of the proximal hollow section of the thrust piece may be different from, preferably lesser than, an inner diameter of the distal hollow section of the thrust piece.

The thrust piece may comprise an intermediate hollow section between the distal and the proximal hollow sections, the intermediate hollow section comprising the recess.

A distal end of the proximal hollow section of the sealing element may abut the distal end of the capillary tube. In other words, the capillary tube may be inserted into the proximal hollow section of the sealing element.

An inner diameter of the proximal hollow section of the sealing element may be different from, preferably greater than, an inner diameter of the intermediate hollow section of the sealing element.

An inner diameter of the distal hollow section of the sealing element may increase in the distal direction.

The inner diameter of the proximal hollow section of the sealing element may be greater than a maximum inner diameter of the distal hollow section of the sealing element.

An outer diameter of the capillary tube may be lesser than an inner diameter of the thrust piece.

An outer diameter of the capillary tube may be lesser than an inner diameter of the capillary entrance.

An outer diameter of the distal end of the sealing element may be lesser than an inner diameter of the distal end of the thrust piece.

An outer diameter of at least a part of the sealing element may be lesser than an inner diameter of the distal hollow section of the thrust piece.

An outer diameter of the sealing element may be greater than an inner diameter of the proximal hollow section of the thrust piece.

An outer diameter of the capillary tube may be lesser than an inner diameter of the proximal hollow section of the sealing element.

An outer diameter of the capillary tube may be greater than an inner diameter of the distal hollow section of the sealing element.

An inner diameter of the capillary tube may be lesser than an inner diameter of the distal hollow section of the sealing element.

An outer diameter of the capillary tube may be in the range defined by 150 μm and 1000 μm, preferably by 500 μm and 1000 μm.

An outer diameter of the distal end of the sealing element may be in the range defined by 1000 μm and 1400 μm.

A maximum extension of the sealing element, in a direction, at least substantially, parallel to the axial direction, may be in the range defined by 400 μm and 1200 μm.

A maximum extension of the distal hollow section of the thrust piece, in a direction, at least substantially, parallel to the axial direction, may be in the range defined by 4000 μm and 11000 μm.

An inner diameter of the distal hollow section of the thrust piece may be in the range defined by 100 μm and 1800 μm, preferably by 150 μm and 1600 μm, further preferably by 300 μm and 1200 μm.

The sealing element may be made of polymer material, such as polyether ether ketone (PEEK), reinforced PEEK, polytetrafluoroethylene (PTFE), polyimide (e.g., Vespel), or polyamide-imide (e.g., Torlon).

The thrust piece may be made of metal, preferably of stainless steel or titanium.

The assembly may be configured for use in high performance liquid chromatography.

A bulk modulus of a material of the sealing element may be in the range defined by 30 MPa and 500 MPa, preferably by 50 MPa and 300 MPa, further preferably by 100 MPa and 200 MPa, yet further preferably by 125 MPa and 175 MPa.

The sealing element may be configured to move in the axial direction with respect to the thrust piece by a distance in the range defined by 0.03 mm and 0.8 mm, preferably by 0.05 mm and 0.5 mm, further preferably by 0.2 mm and 0.4 mm.

A ratio of the extension of the recess in the axial direction with the extension of the engagement element in the axial direction may be greater than 1.05, preferably greater than 1.10, further preferably greater than 1.15.

A ratio of the extension of the recess in the axial direction with the extension of the engagement element in the axial direction may be lesser than 1.5, preferably lesser than 1.40, further preferably lesser than 1.30.

A ratio of the distance of the recess from the distal end and the distance of the recess from the proximal end may be less than 0.5, preferably less than 0.2, further preferably less than 0.1.

According to a second aspect, the present invention relates to a system comprising: an assembly as described above, and a bushing unit for receiving the assembly, or at least a distal section thereof.

A distal end of the sealing element may contact the busing unit when the assembly is received in the bushing unit.

A distal end of the thrust piece may contact the bushing unit when the assembly is received in the busing unit.

According to a third aspect, the present invention relates to use of the assembly as described above or of the system as described above.

The use may comprise use in high performance liquid chromatography.

The use may comprise conveying a liquid at an elevated pressure through a capillary.

The elevated pressure may be at least 300 bar, preferably at least 500 bar, further preferably at least 1000 bar, yet further preferably at least 1500 bar.

The assembly may comprise an assembly as described above and the system may comprise a system as described above, wherein the use may comprise: inserting the assembly into the bushing unit; the sealing element contacting a bottom section of the bushing unit; the proximal end of the proximal hollow section of the sealing element abutting the distal end of the capillary tube; and forcing the capillary tube in the distal direction.

A result of forcing the capillary tube may be the distal face of the sealing element contacting the bottom section and the distal face of the thrust piece contacting the bottom section.

According to a fourth aspect, the present invention relates to a method comprising providing an assembly as described above.

The method may comprise determining the extension of the recess in the axial direction based, at least in part, on the extension of the engagement element in the axial direction.

The method may comprise determining an extension of the recess in a direction, at least substantially, perpendicular to the axial direction.

The method may comprise determining the extension of the recess based, at least in part, on a Young's modulus and/or a shear modulus and/or a bulk modulus of a material of the sealing element. For example, an expected deformation of the sealing element due to connection with the bushing unit may be determined based, at least in part, on the bulk modulus of the material. Based on the expected deformation, a size of the recess may be determined to allow for the expected deformation of the sealing element with at least reduced additional stress.

The assembly may be intended for use as described above, and the method may comprise determining the extension of the recess based, at least in part, on the value of the elevated pressure.

The present invention is also described by the following numbered embodiments.

Below assembly embodiments will be discussed. These are abbreviated by the letter “A” followed by a number. Whenever reference is herein made to the “assembly embodiments”, the following embodiments are meant.

A1. A capillary assembly (1000) comprising:
a capillary tube (3);
a thrust piece (2) surrounding at least a distal section of the capillary tube (3), the thrust piece (2) defining an axial direction;
a sealing element (1);
wherein at least a portion of the sealing element (1) is arranged distally from the capillary tube (3);
wherein the sealing element (1) is configured to move in the axial direction relative to the thrust piece (2).

A2. The assembly according to the preceding embodiment, wherein a proximal part of the sealing element is movable in the axial direction relative to the thrust piece.

A3. The assembly according to any of the 2 preceding embodiments, wherein the thrust piece comprises a recess, and wherein the sealing element is coupled to the recess.

A4. The assembly according to the preceding embodiment, wherein the sealing element comprises an engagement element, and wherein the engagement element coupled to the recess.

A5. The assembly according to the preceding embodiment, wherein an extension of the recess in the axial direction is greater than an extension of the engagement element in the axial direction.

A6. The assembly according to any of the preceding assembly embodiments, wherein the thrust piece comprises at least one hollow section defined by an inner and an outer wall.

A hollow section, as used herein, may generally be understood to be a space defined by an inner wall and an outer wall.

A7. The assembly according to the preceding embodiment, wherein the thrust piece consists of the at least one hollow section.

A8. The assembly according to any of the 2 preceding embodiments and with the features of embodiment A3, wherein the recess is arranged on the inner wall.

A9. The assembly according to any of the 3 preceding embodiments, wherein the recess is located closer to a distal end of the thrust piece than to a proximal end of the thrust piece.

A10. The assembly according to any of the preceding assembly embodiments, wherein the thrust piece comprises a proximal end comprising a capillary entrance, and wherein the thrust piece is configured to receive the capillary tube through the capillary entrance.

A11. The assembly according to any of the preceding assembly embodiments, wherein the sealing element is located so as to abut a distal end of the capillary tube.

A12. The assembly according to any of the preceding assembly embodiments, wherein the thrust piece is configured to receive the sealing element, or at least a part thereof.

A13. The assembly according to the preceding embodiment, wherein the thrust piece is configured to receive the sealing element, or the part thereof, at a distal end of the thrust piece.

A14. The assembly according to any of the preceding assembly embodiments, wherein the sealing element comprises a distal end.

A15. The assembly according to any of the preceding assembly embodiments, wherein the thrust piece comprises a distal end.

A16. The assembly according to any of the preceding assembly embodiments and with the features of embodiment A3, wherein the recess comprises two shoulders, a proximal shoulder closer to a proximal end of the thrust piece and a distal shoulder closer to a distal end of the thrust piece.

A17. The assembly according to the preceding embodiment and with the features of embodiment A5, wherein a result of the extension of the recess, in the axial direction, being greater than an extension of the engagement element, in the axial direction, is the sealing element being configured to move between a distal position, wherein the distal shoulder abuts the engagement element, and a proximal position, wherein the proximal shoulder abuts the engagement element.

A18. The assembly according to the preceding embodiment and with the features of embodiments A14, and A15, wherein, in the distal position, the distal end of the sealing element, or at least a part thereof, extends beyond the distal end of the thrust piece, or at least a part thereof.

A19. The assembly according to any of the 2 preceding embodiments and with the features of embodiments A14, and A15, wherein, in the proximal position, the distal end of the sealing element, or at least a part thereof, is level with the distal end of the thrust piece, or at least a part thereof.

A20. The assembly according to any of the preceding assembly embodiments and with the features of embodiment A14, wherein the distal end of the sealing element comprises a distal face.

A21. The assembly according to any of the preceding plug unit embodiments and with the features of embodiment A15, wherein the distal end of the thrust piece comprises a distal face.

A22. The assembly according to the preceding embodiment and with the features of embodiments A19, and A20, wherein, in the proximal position, the distal face of the sealing element is level with the distal face of the thrust piece.

A23. The assembly according to any of the preceding assembly embodiments, wherein the recess comprises a step, wherein the step divides the recess into a side proximal of the step, and a side distal of the step.

A24. The assembly according to the preceding embodiment, wherein a diameter of the recess on the side proximal of the step is different from a diameter on the side distal of the step, and wherein, preferably, the diameter of the recess on the side proximal of the step is at most equal to the diameter on the side distal of the step.

A25. The assembly according the preceding embodiment, wherein the diameter of the recess on the side proximal and/or distal of the step is, at least substantially, constant.

A26. The assembly according to any of the preceding assembly embodiments, wherein the sealing element comprises a proximal end.

A27. The assembly according to the preceding embodiment and with the features of embodiment A14, wherein the engagement element is located closer to the proximal end of the sealing element than to the distal end.

A28. The assembly according to any of the preceding assembly embodiments and with the features of embodiment A26, wherein the proximal end of the sealing element is configured to receive the capillary tube.

A29. The assembly according to any of the preceding assembly embodiments, wherein the sealing element comprises a hollow section, preferably a plurality of hollow sections.

A30. The assembly according to the preceding embodiment, wherein the plurality of hollow sections comprises a proximal hollow section corresponding to a hollow section furthest in the proximal direction, a distal hollow section corresponding to a hollow section furthest in the distal direction, and an intermediate hollow section corresponding to a hollow section in between the distal and proximal hollow sections.

A31. The assembly according to the preceding embodiment, wherein an inner diameter of the proximal hollow section of the sealing element is different from, preferably greater than, an inner diameter of the distal hollow section.

A32. The assembly according to any of the 2 preceding embodiments, wherein the proximal hollow section is configured to receive the capillary tube, particularly the distal end thereof.

A33. The assembly according to any of the preceding assembly embodiments, wherein the sealing element co-extends, along the axial direction, with the capillary tube.

A34. The assembly according to any of the preceding assembly embodiments and with the features of embodiment A30, wherein an outer wall of the proximal hollow section comprises the engagement element.

A35. The assembly according to any of the preceding assembly embodiments and with the features of embodiment A4, wherein the engagement element comprises at least one rib.

A36. The assembly according to the preceding embodiment, wherein the at least one rib is an annular rib.

A37. The assembly according to the penultimate embodiment, wherein the engagement element comprises a plurality of ribs.

A38. The assembly according to the preceding embodiment and with the features of embodiment A34, wherein the plurality of ribs is arranged circumferentially on an outer wall of the proximal hollow section.

A39. The assembly according to any of the preceding assembly embodiments and with the features of embodiment A35, wherein at least one of the at least one rib is tapered along the axial direction, wherein an extension of the at least one of the at least one rib, in a direction, at least substantially, perpendicular to the axial direction, decreases in the proximal direction.

A40. The assembly according to any of the preceding assembly embodiments and with the features of embodiments A17, and A35, wherein the distal shoulder abuts a distal end of at least one of the at least one rib.

A41. The assembly according to any of the preceding assembly embodiments and with the features of embodiments A17, and A35, wherein the proximal shoulder abuts a proximal end of at least one of the at least one rib.

A42. The assembly according to any of the preceding assembly embodiments and with the features of embodiment A26, wherein the proximal end of the sealing element comprises a proximal end of at least one of the at least one ribs.

A43. The assembly according to any of the preceding assembly embodiments and with the features of embodiment A6, wherein the thrust piece comprises a plurality of hollow sections.

A44. The assembly according to the preceding embodiment, wherein the thrust piece comprises a proximal hollow section corresponding to a hollow section furthest in the proximal direction and a distal hollow section corresponding to a hollow section furthest in the distal direction.

A45. The assembly according to the preceding embodiment, wherein an inner diameter of the proximal hollow section of the thrust piece is different from, preferably lesser than, an inner diameter of the distal hollow section of the thrust piece.

A46. The assembly according to any of the 2 preceding embodiments and with the features of embodiment A3, wherein the thrust piece comprises an intermediate hollow section between the distal and the proximal hollow sections, the intermediate hollow section comprising the recess.

A47. The assembly according to any of the preceding assembly embodiments and with the features of embodiments A11, A28, and A30, wherein a distal end of the proximal hollow section of the sealing element abuts the distal end of the capillary tube. In other words, the capillary tube may be inserted into the proximal hollow section of the sealing element.

A48. The assembly according to any of the preceding assembly embodiments and with the features of embodiment A30, wherein an inner diameter of the proximal hollow section of the sealing element is different from, preferably greater than, an inner diameter of the intermediate hollow section of the sealing element.

A49. The assembly according to any of the preceding assembly embodiments and with the features of embodiment A30, wherein an inner diameter of the distal hollow section of the sealing element increases in the distal direction.

A50. The assembly according to the preceding embodiment and with the features of embodiment A31, wherein the inner diameter of the proximal hollow section of the sealing element is greater than a maximum inner diameter of the distal hollow section of the sealing element.

A51. The assembly according to any of the preceding assembly embodiments, wherein an outer diameter of the capillary tube is lesser than an inner diameter of the thrust piece.

A52. The assembly according to any of the preceding assembly embodiments and with the features of embodiment A10, wherein an outer diameter of the capillary tube is lesser than an inner diameter of the capillary entrance.

A53. The assembly according to any of the preceding assembly embodiments and with the features of embodiments A14, and A15, wherein an outer diameter of the distal end of the sealing element is lesser than an inner diameter of the distal end of the thrust piece.

A54. The assembly according to any of the preceding assembly embodiments and with the features of embodiment A44, wherein an outer diameter of at least a part of the sealing element is lesser than an inner diameter of the distal hollow section of the thrust piece.

A55. The assembly according to any of the preceding assembly embodiments and with the features of embodiment A44, wherein an outer diameter of the sealing element is greater than an inner diameter of the proximal hollow section of the thrust piece.

A56. The assembly according to any of the preceding assembly embodiments and with the features of embodiments A28, and A30, wherein an outer diameter of the capillary tube is lesser than an inner diameter of the proximal hollow section of the sealing element.

A57. The assembly according to any of the preceding assembly embodiments and with the features of embodiments A28, and A30, wherein an outer diameter of the capillary tube is greater than an inner diameter of the distal hollow section of the sealing element.

A58. The assembly according to any of the preceding assembly embodiments and with the features of embodiments A28, and A30, wherein an inner diameter of the capillary tube is lesser than an inner diameter of the distal hollow section of the sealing element.

A59. The assembly according to any of the preceding assembly embodiments and with the features of any of embodiments A10, and A28, wherein an outer diameter of the capillary tube is in the range defined by 150 μm and 1000 μm, preferably by 500 μm and 1000 μm.

A60. The assembly according to any of the preceding assembly embodiments and with the features of embodiment A14, wherein an outer diameter of the distal end of the sealing element is in the range defined by 1000 μm and 1400 μm.

A61. The assembly according to any of the preceding assembly embodiments, wherein a maximum extension of the sealing element, in a direction, at least substantially, parallel to the axial direction, is in the range defined by 400 μm and 1200 μm.

A62. The assembly according to any of the preceding assembly embodiments and with the features of embodiment A44, wherein a maximum extension of the distal hollow section of the thrust piece, in a direction, at least substantially, parallel to the axial direction, is in the range defined by 4000 μm and 11000 μm.

A63. The assembly according to any of the preceding assembly embodiments and with the features of embodiment A44, wherein an inner diameter of the distal hollow section of the thrust piece is in the range defined by 100 μm and 1800 μm, preferably by 150 μm and 1600 μm, further preferably by 300 μm and 1200 μm.

A64. The assembly according to any of the preceding assembly embodiments, wherein the sealing element is made of polymer material, such as polyether ether ketone (PEEK), reinforced PEEK, polytetrafluoroethylene (PTFE), polyimide (e.g., Vespel), or polyamide-imide (e.g., Torlon).

A65. The assembly according to any of the preceding assembly embodiments, wherein the thrust piece is made of metal, preferably of stainless steel or titanium.

A66. The assembly according to any of the preceding assembly embodiments, wherein the assembly is configured for use in high performance liquid chromatography.

A67. The assembly according to any of the preceding assembly embodiments, wherein a bulk modulus of a material of the sealing element is in the range defined by 30 MPa and 500 MPa, preferably by 50 MPa and 300 MPa, further preferably by 100 MPa and 200 MPa, yet further preferably by 125 MPa and 175 MPa.

A68. The assembly according to any of the preceding assembly embodiments, wherein the sealing element is configured to move in the axial direction with respect to the thrust piece by a distance in the range defined by 0.03 mm and 0.8 mm, preferably by 0.05 mm and 0.5 mm, further preferably by 0.2 mm and 0.4 mm.

A69. The assembly according to any of the preceding assembly embodiments and with the features of embodiment A5, wherein a ratio of the extension of the recess in the axial direction with the extension of the engagement element in the axial direction is greater than 1.05, preferably greater than 1.10, further preferably greater than 1.15.

A70. The assembly according to any of the preceding assembly embodiments and with the features of embodiment A5, wherein a ratio of the extension of the recess in the axial direction with the extension of the engagement element in the axial direction is lesser than 1.5, preferably lesser than 1.40, further preferably lesser than 1.30.

A71. The assembly according to any of the preceding assembly embodiments and with the features of embodiment A9, wherein a ratio of the distance of the recess from the distal end and the distance of the recess from the proximal end is less than 0.5, preferably less than 0.2, further preferably less than 0.1.

Below system embodiments will be discussed. These are abbreviated by the letter “S” followed by a number. Whenever reference is herein made to the “system embodiments”, the following embodiments are meant.

S1. A system comprising:
an assembly according to any of the preceding assembly embodiments, and
a bushing unit for receiving the assembly, or at least a distal section thereof.

S2. The system according to the preceding embodiment, wherein, when the assembly is received in the bushing unit, a distal end of the sealing element contacts the busing unit.

S3. The system according to any of the 2 preceding embodiments, wherein, when the assembly is received in the busing unit, a distal end of the thrust piece contacts the bushing unit.

Below use embodiments will be discussed. These are abbreviated by the letter “U” followed by a number. Whenever reference is herein made to the “method embodiments”, the following embodiments are meant.

U1. Use of the assembly according to any of the preceding assembly embodiments or of the system according to any of the preceding system embodiments.

U2. The use according to the preceding embodiment, wherein the use comprises use in high performance liquid chromatography.

U3. The use according to any of the preceding use embodiments, wherein the use comprises conveying a liquid at an elevated pressure through a capillary.

U4. The use according to the preceding embodiment, wherein the elevated pressure is at least 300 bar, preferably at least 500 bar, further preferably at least 1000 bar, yet further preferably at least 1500 bar.

U5. The use according to any of the preceding use embodiments, wherein the assembly comprises an assembly with the features of embodiment A47 and the system comprises a system with the features of embodiment S1, wherein the use comprises:
inserting the assembly into the bushing unit;
the sealing element contacting a bottom section of the bushing unit;
the proximal end of the proximal hollow section of the sealing element abutting the distal end of the capillary tube; and
forcing the capillary tube in the distal direction.

U6. The use according to the preceding embodiment, wherein the assembly further comprises the features of embodiment A22, wherein a result of forcing the capillary tube is the distal face of the sealing element contacting the bottom section and the distal face of the thrust piece contacting the bottom section.

Below method embodiments will be discussed. These are abbreviated by the letter “M” followed by a number. Whenever reference is herein made to the “method embodiments”, the following embodiments are meant.

M1. A method comprising providing an assembly according to any of the assembly embodiments.

M2. The method according to the preceding embodiment, wherein the method comprises providing the assembly according to embodiment A5, wherein the method comprises determining the extension of the recess in the axial direction based, at least in part, on the extension of the engagement element in the axial direction.

M3. The method according to any of the preceding method embodiments, wherein the method comprises determining an extension of the recess in a direction, at least substantially, perpendicular to the axial direction.

M4. The method according to any of the 2 preceding embodiments, wherein the method comprises determining the extension of the recess based, at least in part, on a Young's modulus and/or a shear modulus and/or a bulk modulus of a material of the sealing element.

M5. The method according to any of the preceding method embodiments and with the features of any of embodiments M2, and M3, wherein the assembly is intended for use according to embodiment U4, wherein the method comprises determining the extension of the recess based, at least in part, on the value of the elevated pressure.

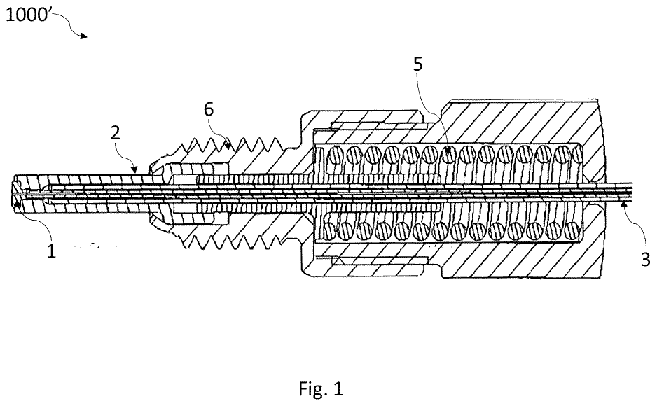

FIG. 1 depicts a typical capillary assembly known from the prior art;

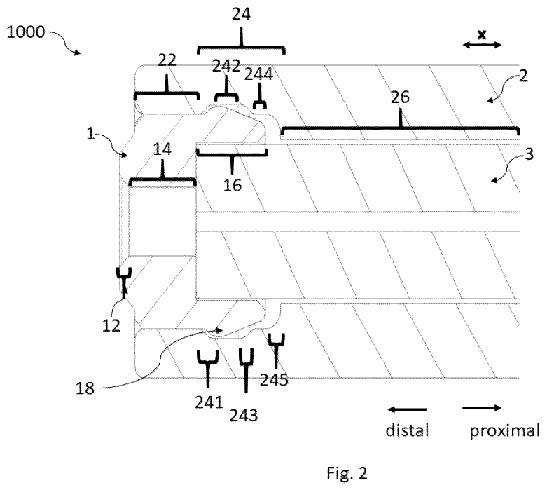

FIG. 2 depicts a first configuration of a capillary assembly according to the present invention;

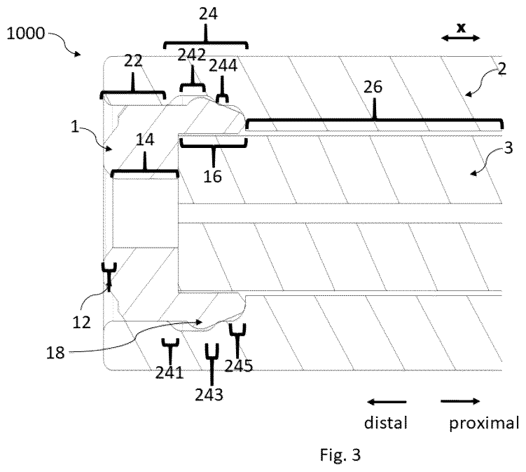

FIG. 3 depicts a second configuration of the capillary assembly according to the present invention;

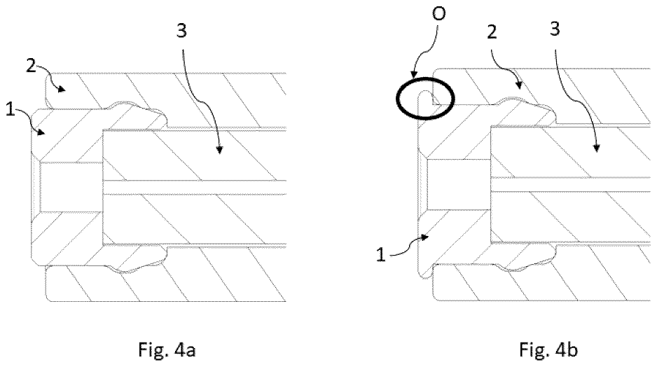

FIG. 4a depicts a sealing element before prolonged use;

FIG. 4b depicts a sealing element after prolonged use;

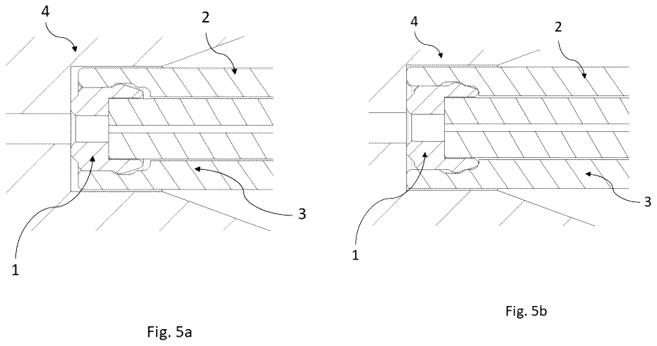

FIG. 5a depicts a capillary assembly according to the present invention together with a bushing unit; and

FIG. 5b depicts a capillary assembly according to the present invention receiving in a bushing unit.

FIG. 1 depicts a well-known capillary assembly 1000′ from prior art. As described above, the capillary assembly 1000′ may be used to connect capillary tubes with each other in HPLC systems. In particular, the capillary assembly 1000′ may allow connecting capillary tubes carrying fluid at high pressure, such as in the range defined by 500 and 2000 bar, without a significant drop in pressure, for example, due to leaks across the connection. In general, the connection may be made by pushing two capillary tubes against each other with sufficient force so that leaking is minimized. Capillary assembly 1000′, together with a bushing unit 4 (c.f., FIGS. 5a and 5b), may allow such a connection to be made.

The capillary assembly 1000′ comprises a sealing element 1, held by a thrust piece 2, a housing 6, and a biasing means 5. The capillary assembly 1000′ is further configured for receiving a capillary tube 3. The biasing means 5 may comprise, for example, a spring, and is used, at least in part, to bias the housing 6 towards the thrust piece 2. However, the skilled person may appreciate that a capillary assembly according to the present invention may not necessarily comprise the biasing means 5.

In operation, threads on the housing 6 are engaged with complementary threads on the bushing unit 4 by screwing the capillary assembly 1000′ into the bushing unit 4. Screwing-in the capillary assembly 1000′ causes translation of the sealing element 1, the thrust piece 2, and the capillary tube 3 into the bushing unit 4 until the sealing element 1 encounters an abutment face 42 (c.f., FIGS. 5 a and 5 b) of the bushing unit 4. Further screwing-in of the capillary assembly 1000′ then causes the housing 6, together with the biasing means 5, to move towards the bushing unit 4 relative to the thrust piece 2 and the sealing element 1, eventually making contact with the thrust piece 2 and pushing against the abutment face 42 of the bushing unit 4. As the capillary assembly 1000′ is screwed further, a greater pressing force is applied onto the sealing element 1 and the thrust piece 2, allowing a tight connection between the capillary assembly 1000′ and the bushing unit 4 to be made.

The direction of translation of the sealing element 1, or generally the capillary assembly 1000′, towards the bushing unit 4 may be referred to as an axial direction, defining a distal direction, corresponding to a direction towards the bushing unit 4, and a proximal direction, corresponding to a direction away from the bushing unit 4. In other words, the distal direction may correspond to the direction of motion of the capillary assembly 1000′ when being screwed in to the bushing unit 4 and the proximal direction may correspond to the direction of motion of the capillary assembly 1000′ when being screwed out of the of bushing unit 4.

As depicted in FIG. 1, a distal face of the sealing element 1 protrudes axially out of a distal face of the thrust piece 2. Thus, when the capillary assembly 1000′ has been fully screwed in to the bushing unit 4, the distal face of the sealing element 1 presses against the abutment face 42 of the bushing unit 4 with a force determined by the screwing mechanism between the capillary assembly 1000′ and the bushing unit 4. The pressing force is distributed over the area of contact and, thus, over the area of the distal face of the sealing element 1. The resulting pressure of contact, defined as the force of contact per unit area of contact (P=F/A), may be proportional to the pressure of the fluid in the capillary tube 3. Thus, in order to use the capillary assembly 1000′ to connect two capillary tubes 3 carrying fluid of a defined pressure, the capillary assembly 1000′, and also the corresponding bushing unit 4, may be designed such that a corresponding defined pressure of contact may be generated.

Over multiple screw-ins, or over prolonged use, the pressure of contact may cause the sealing element 1 to deform. An exemplary illustration of this deformation is depicted in FIG. 4b, that depicts a sealing element 1 before (FIG. 4a) and after prolonged use.

As depicted in FIG. 4b, deformation of the sealing element 1 may cause the distal face of the sealing element 1 to protrude radially over the distal face of the thrust piece 2, as indicated by ‘O’. When the deformed sealing element 1 is used to contact the abutment face 42 of the bushing unit 4, the area of contact is larger than that of an undeformed sealing element 1, as depicted in FIG. 4a. Thus, in order to generate the same pressure of contact, a larger force of contact may be needed. Moreover, the deformation may also occur radially inward, such that an inner bore of the sealing element 1 may, at least partially, close, resulting in increased backpressure in the capillary tube 3 and, possibly, clogging. As described above, embodiments of the present technology may allow alleviating some of these problems.

FIGS. 2 and 3 depict two configurations of a capillary assembly 1000 according to an embodiment of the present invention. In particular, FIGS. 2 and 3 depict a zoomed-in view of a distal end of the capillary assembly 1000 such that the housing 4 or the biasing means 5 are not shown. FIGS. 2 and 3 depict the sealing element 1, the thrust piece 2, and the capillary tube 3 of the capillary assembly 1000 according to the present invention. FIGS. 2 and 3 also depict the axial direction ‘x’.

With reference to FIGS. 2 and 3, the thrust piece 2 may comprise a hollow section, preferably a plurality of hollow sections, such as two hollow sections 22 and 26. A hollow section, as used herein, may generally be understood to comprise a space defined by an inner and an outer wall surrounding the space. The hollow section 22 may be referred to as a distal hollow section and the hollow section 26 may be referred to as a proximal hollow section of the thrust piece 2. An inner diameter of the distal hollow section 22 may be greater than an inner diameter of the proximal hollow section 26.

The two hollow sections 22 and 26 may be connected by means of an intermediate hollow section comprising a recess 24.

The inner diameter of the proximal hollow section 26 may be chosen so as to accommodate a distal end of the capillary tube 3. In particular, the inner diameter of the proximal hollow section 26 may be greater than an outer diameter of the distal end of the capillary tube 3.

The inner diameter of the distal hollow section 22 may be chosen so as to accommodate a distal end of the sealing element 1. In particular, the inner diameter of the distal hollow section 22 may be larger than an outer diameter of the distal end of the sealing element 1.

The recess 24 may be defined on an inner wall of the intermediate hollow section of the thrust piece 2, connecting the distal and the proximal hollow sections 22 and 26 respectively. The recess 24 may comprise two shoulders, a distal shoulder 241 and a proximal shoulder 245. The distal shoulder 241 and the proximal shoulder 245 may define ends of the recess 24 in the axial direction. The distal shoulder 241 and the proximal shoulder 245 may be configured to abut the sealing element 1 received in the thrust piece 2, preferably in a distal section of the thrust piece 2, such that the sealing element 1 may move, at least in the axial direction ‘x’, with respect to the thrust piece 2.

The recess 24 may further comprise a step 243 dividing the recess 24 into a side 242 distal of the step 243 and a side 244 proximal of the step 243. The side 244 proximal of the step 243 may be understood to comprise a portion of the recess 24 that is closer to the proximal end of the capillary assembly 1000 and that does not contain the step 243. The side 242 distal of the step 243 may, similarly, be understood to comprise a portion of the recess 24 that is closer to the distal end of the capillary assembly 1000 and that does not contain the step 243.

An inner diameter of the recess 24 on the side 242 distal of the step 243 may be greater than the inner diameter of the distal hollow section 22 of the thrust piece 2. An inner diameter of the recess 24 on the side 244 proximal of the step 243 may be greater than the inner diameter of the proximal hollow section 26 of the thrust piece 2.

The inner diameter on the side 242 distal of the step 243 may be greater than the inner diameter on the side 244 proximal of the step 243. The inner diameter of the recess 24 on any of the sides, distal 242 and proximal 244, of the step 243 may be uniform or non-uniform.

The capillary assembly 1000 may comprise the sealing element 1, as depicted in FIGS. 2 and 3. The sealing element 1 may comprise a plurality of hollow sections, such as a distal hollow section 12, a proximal hollow section 16, and an intermediate hollow section 14 in between the distal and proximal hollow sections 12 and 16 respectively. Inner diameters of the hollow sections 12, 14, and 16 of the sealing element 1 may vary as depicted in FIGS. 2 and 3.

In other words, the inner diameter of the proximal hollow section 16 may be greater than the inner diameter of the intermediate hollow section 14. The inner diameter of the distal hollow section 12 may be non-uniform and may increase in the distal direction. A maximum inner diameter of the distal hollow section 12 may be lesser than the inner diameter of the proximal hollow section 16. A minimum inner diameter of the distal hollow section 12 may be, at least significantly, identical to the inner diameter of the intermediate hollow section 14.

The proximal hollow section 16 of the sealing element 1 may be configured to receive the distal end of the capillary tube 3. In particular, the distal end of the proximal hollow section 16 may abut the distal end of the capillary tube 3 and the proximal end of the proximal hollow section may comprise an opening for inserting the capillary tube 3. The inner diameter of the proximal hollow section 16 may be greater than the outer diameter of the capillary tube 3. The inner diameter of the proximal hollow section 16 may be, at least significantly, identical to the inner diameter of the proximal hollow section 26 of the thrust piece 2.

The sealing element 1 may comprise the engagement element 18. The engagement element 18 may be located closer to a proximal end of the sealing element 1 than to a distal end. The engagement element 18 may be configured to engage/couple with the recess 24 such that the sealing element 1 may move with respect to the thrust piece 2 between a first position, that may be referred to as a distal position, as depicted in FIG. 2, and a second position, that may be referred to as a proximal position, as depicted in FIG. 3.

An extension of the recess 24, in the axial direction, may, in particular, be greater than an extension of the engagement element 18 in the axial direction. A result of the coupling and the difference in extensions between the engagement element 18 and the recess 24 may be the movement, in at least the axial direction, of the sealing element 1 relative to the thrust piece 2.

The distal shoulder 241 of the recess 24, or, more generally, a distal part of the thrust piece 2, may abut the engagement element 18 in the distal position, whereas the proximal shoulder 245 of the recess 24, or, more generally, a proximal part of the thrust piece 2, may abut the engagement element 18 in the proximal position.

A distal end of the sealing element 1, that may comprise a distal face, may, in the distal position, extend, in the axial direction, beyond a distal end of the thrust piece 2. The distal face of the sealing element 1 may be level with the distal end of the thrust piece 2 in the proximal position. In other words, in the proximal position, a distal face of thrust piece 2 and the distal face of the sealing element 1 may lie, at least significantly, in the same plane.

The engagement element 18 may be located on an outer wall of the proximal hollow section 16 of the sealing element 1.

The engagement element 18 may comprise at least one rib 18. A rib 18 may generally be understood to correspond to a protrusion. The at least one rib 18 may comprise an annular rib 18 extending around the proximal hollow section 16. Alternatively, the engagement element 18 may comprise a plurality of ribs 18. The plurality of ribs 18 may be arranged circumferentially around the proximal hollow section 16.

At least one of the at least one rib 18 may be tapered along the axial direction, wherein an extension of the at least one of the at least one rib 18, in a direction, at least significantly, perpendicular to the axial direction, may decrease in the proximal direction. In embodiments where the at least one rib 18 comprises an annular rib 18, only some sections of the annular rib 18 may, for example, be tapered.

The skilled person understands that the shape of the at least one rib 18 described above is exemplary, but not limiting, and other shapes may be possible. For example, the at least one rib 18 may comprise a rectangular shape or a hemispherical shape. The recess 24, particularly the proximal shoulder 245 and the distal shoulder 241 thereof, may be shaped appropriately to allow for sufficient contact force to be generated to keep the capillary assembly 1000 in contact with the bushing unit 4 in operation or to provide sufficient force when the capillary tube 3 is inserted into the thrust piece 2, as described above.

The distal shoulder 241 of the recess 24 may abut a distal end of at least one of the at least one rib 18, or, generally, of the engagement element 18, in the distal position of the sealing element 1. The proximal shoulder 245 of the recess 24 may abut a proximal end of at least one of the at least one rib 18, or, generally, of the engagement element 18, in the proximal position of the sealing element 1.

The inner diameter of the side 242 distal of the step 243 of the recess 24 may be greater than a maximum extension of at least one of the at least one rib 18 in the direction, at least significantly, perpendicular to the axial direction.

The inner diameter of the side 244 proximal of the step 243 of the recess 24 may be greater than a maximum extension of the proximal end of at least one of the at least one rib 18 in the direction, at least significantly, perpendicular to the axial direction.

As a result of the greater extension of the recess 24, in the axial direction, and, optionally, the direction perpendicular to the axial direction, possible deformation of the sealing element 1 may not close the inner bore of the sealing element 1, i.e., may not change, at least significantly, the inner diameters of the distal and intermediate hollow sections 12 and 14 respectively. Further, as the distal face of the sealing element 1 that contacts the abutment face 42 of the bushing unit 4 attains the configuration depicted in FIG. 3, in operation, increase in the surface area of contact, i.e., the surface area of the distal face of the sealing element 1, due to deformation may be mitigated, thus maintaining, at least substantially, the same force of contact for the same pressure of contact.

Thus, embodiments of the present technology provide a capillary assembly 1000 in which the sealing element 1 may be moved in the thrust piece 2. As a result, the contact surface area of the sealing element 1 with the abutment face 42 of the bushing unit 4 may remain, at least substantially, the same, and, therefore, also the required sealing force.

The sealing element 1 may be fixed in the thrust piece 2 in such a way that axial movement may be allowed. The sealing surface, corresponding to the distal face of the sealing element 1, may typically be of the same size and therefore also the required sealing force.

The sealing element 1 may, thus, have a significantly longer service life, wear may be lower and the performance of the sealing element 1 may degrade less over a longer period of time.

In other words, the sealing element 1 may be movable in the thrust piece 2 according to the present technology. An advantage of this movement may be that the surface area may nearly be the same in over prolonged use such that the sealing/tightening/contact force may be nearly the same.

If the sealing element 1 were not movable in the thrust piece 2, as depicted, for example, in FIGS. 4a and 4b, the sealing element 1 may be compressed and may get deformed to a greater diameter, as indicated by ‘O’. A disadvantage of the deformation may be that the surface area of contact may increase, and the tightening/sealing/contact force may then also increase. Another disadvantage may be that the thrust piece 2 may no more be able to touch the abutment face 42 of the bushing unit 4 because of the portion of the sealing element 1 in front of the thrust piece 2.

FIGS. 5a and 5b depict the capillary assembly 1000 being received in the bushing unit 4. As depicted in FIG. 5a, the bushing unit 4 may be configured so as to receive the capillary assembly 1000, or at least the distal part thereof. In particular, an inner diameter of a proximal end of the bushing unit 4 may be greater than an outer diameter of the thrust piece 2. In operation, the capillary assembly 1000 may be pressed against the bushing unit 4 as depicted in FIG. 5b. As described above, the capillary assembly 1000 may be pressed with a pressure that may be proportional to a pressure of the fluid which is to be carried through the capillary tube 3. When the capillary assembly 1000 is pressed against the bushing unit 4, the sealing element 1 and the capillary tube 3 may move axially towards the proximal direction relative to the thrust piece 2 such that the abutment face 42 of the bushing unit 4 touches the distal end of the thrust piece 2 and the distal end of the sealing element 1.

As further depicted in FIGS. 5a and 5b, the maximum diameter of the distal hollow section 12 of the sealing element 1 may be chosen based, at least in part, on an inner diameter of a corresponding hollow section 44 of the bushing unit 4.

Overall, embodiments of the present technology thus provide a capillary assembly that may be more robust with respect to force of contact, more resistant to wear, and that may have a longer lifetime.

While in the above, a preferred embodiment has been described with reference to the accompanying drawings, the skilled person will understand that this embodiment was provided for illustrative purpose only and should by no means be construed to limit the scope of the present invention, which is defined by the claims.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A capillary assembly comprising:
a capillary tube;
a thrust piece surrounding at least a distal section of the capillary tube, the thrust piece defining an axial direction;
a sealing element;
wherein at least a portion of the sealing element is arranged distally from the capillary tube;
wherein the sealing element is configured to move in the axial direction relative to the thrust piece.

2. The assembly according to claim 1, wherein a proximal part of the sealing element is movable in the axial direction relative to the thrust piece.

3. The assembly according to claim 1, wherein the thrust piece comprises a recess, and wherein the sealing element is coupled to the recess.

4. The assembly according to claim 3, wherein the sealing element comprises an engagement element, and wherein the engagement element coupled to the recess.

5. The assembly according to claim 4, wherein an extension of the recess in the axial direction is greater than an extension of the engagement element in the axial direction.

6. The assembly according to claim 3, wherein the thrust piece comprises at least one hollow section defined by an inner and an outer wall, wherein the recess is arranged on the inner wall, and wherein the recess is located closer to a distal end of the thrust piece than to a proximal end of the thrust piece.

7. The assembly according to claim 4, wherein the recess comprises two shoulders, a proximal shoulder closer to a proximal end of the thrust piece and a distal shoulder closer to a distal end of the thrust piece, and wherein a result of the extension of the recess, in the axial direction, being greater than an extension of the engagement element, in the axial direction, is the sealing element being configured to move between a distal position, wherein the distal shoulder abuts the engagement element, and a proximal position, wherein the proximal shoulder abuts the engagement element.

8. The assembly according to claim 7, wherein the sealing element comprises a distal end, and wherein the thrust piece comprises a distal end, wherein, in the proximal position, the distal end of the sealing element, or at least a part thereof, is level with the distal end of the thrust piece, or at least a part thereof.

9. The assembly according to claim 1, wherein the sealing element comprises a proximal end, wherein the proximal end of the sealing element is configured to receive the capillary tube.

10. The assembly according to claim 1, wherein the sealing element co-extends, along the axial direction, with the capillary tube.

11. The assembly according to claim 4, wherein the engagement element comprises at least one rib.

12. A system comprising:
an assembly including
a capillary tube;
a thrust piece surrounding at least a distal section of the capillary tube, the thrust piece defining an axial direction;
a sealing element;
wherein at least a portion of the sealing element is arranged distally from the capillary tube;
wherein the sealing element is configured to move in the axial direction relative to the thrust piece, and
a bushing unit for receiving the assembly, or at least a distal section thereof.

13. The system according to claim 12, wherein, when the assembly is received in the bushing unit, a distal end of the sealing element contacts the busing unit, and wherein, when the assembly is received in the busing unit, a distal end of the thrust piece contacts the bushing unit.
